(19) United States
(12) Patent Application Publication
(10) Pub. No.: US 2013/0145908 A1
(43) Pub. Date: Jun. 13, 2013

(54) Drive tool device having two or more drives

(71) Applicants: Jun Chung Lee, Taichung (TW); Yi Cheng Li, Taichung (TW)

(72) Inventors: Jun Chung Lee, Taichung (TW); Yi Cheng Li, Taichung (TW)

(21) Appl. No.: 13/374,032

(22) Filed: Dec. 7, 2011

(51) Int. Cl. B25B 23/16

(52) U.S. Cl. 81/177.85

(57) ABSTRACT

A drive tool device includes a drive handle having two end portions, and a fitting pivotally attached to one of the end portions of the drive handle with a pivot shaft for allowing the fitting to be pivoted and rotated relative to the drive handle, the fitting includes two drives for selectively and changeably aligning with the longitudinal axis (L) of the drive handle, the drives of the fitting are perpendicular to each other, and include different dimensions for allowing the user to easily conduct various fastener actuating or driving operations. The drive handle includes a spring-biased projection for engaging with the fitting and for positioning the fitting to the drive handle at selected positions.

### BACKGROUND OF THE INVENTION

1. Field of the Invention

The present invention relates to a drive tool device, and more particularly to a drive tool device including a fitting or adapter having two or more drives for selectively or changeably engaging with different tool elements or extensions or fasteners and for allowing the user to easily and quickly conduct various fastener actuating or driving operations.

2. Description of the Prior Art

Typical drive tool devices comprise a drive shank or drive socket solidly or pivotally attached or mounted or secured to one end of a drive handle for engaging with tool elements or extensions or fasteners and for actuating or driving or rotating the tool elements or extensions or fasteners.

For example, U.S. Pat. No. 4,334,445 to Timewell discloses one of the typical Z style speed wrenches comprising an elongated shaft having a drive device at one end to receive a drive member, a socket, a tool element, a tool extension, a fastener, or similar articles.

However, the drive device at the one end of the elongated shaft includes a predetermined size or dimension or standard for engaging with a predetermined drive member, socket, tool element, tool extension, fastener, or similar articles, but may not be provided or used to engage with drive members, sockets, tool elements, tool extensions, fasteners, or articles of different sizes or dimensions or standards.

U.S. Pat. No. 5,279,189 to Marino discloses another typical tool for the application of threaded fasteners comprising a coupling adapted to engage with the component, and a fitting for engaging with and for actuating or driving or rotating the tool elements or extensions or fasteners.

However, similarly, the fitting at one end of a tool handle includes a predetermined size or dimension or standard for engaging with a predetermined drive member, socket, tool element, tool extension, fastener, or similar articles, but may not be provided or used to engage with drive members, sockets, tool elements, tool extensions, fasteners, or articles of different sizes or dimensions or standards.

U.S. Pat. No. 7,367,249 to Chiang discloses a further typical quick release device of a socket wrench comprising a press rod and a push rod disposed in a socket plug so that the push rod can press against the press rod and the press rod can be pushed and returned toward either side.

However, similarly, the socket plug at one end of a tool handle includes a predetermined size or dimension or standard for engaging with a predetermined drive member, socket, tool element, tool extension, fastener, or similar articles, but may not be provided or used to engage with drive members, sockets, tool elements, tool extensions, fasteners, or articles of different sizes or dimensions or standards.

The present invention has arisen to mitigate and/or obviate the afore-described disadvantages of the conventional drive tool devices.

### SUMMARY OF THE INVENTION

The primary objective of the present invention is to provide a drive tool device including a fitting or adapter having two or more drives for selectively or changeably engaging with different tool elements or extensions or fasteners and for allowing the user to easily and quickly conduct various fastener actuating or driving operations.

In accordance with one aspect of the invention, there is provided a drive tool device comprising a drive handle including a first end portion and a second end portion, and including a longitudinal axis (L), and a fitting pivotally attached to the first end portion of the drive handle with a pivot shaft for allowing the fitting to be pivoted and rotated relative to the drive handle, the fitting includes a first drive and a second drive for selectively and changeably aligning with the longitudinal axis (L) of the drive handle.

The first drive and the second drive of the fitting are preferably perpendicular to each other. The first drive and the second drive of the fitting preferably include different dimensions for selectively or changeably engaging with different tool elements or extensions or fasteners. The drive handle includes an engaging opening formed in the second end portion thereof.

The drive handle includes a spring-biased projection for selectively engaging with the fitting and for retaining and positioning the fitting to the drive handle at selected angular positions.

The fitting includes two depressions formed therein and aligned with the first and the second drives respectively for selectively engaging with the spring-biased projection and for selectively anchoring and positioning the first and the second drives of the fitting to the drive handle at selected positions.

The drive handle includes a compartment formed in the first end portion thereof and defined between a first fillet and a second fillet for pivotally engaging with the fitting.

The pivot shaft is engaged with the first and the second fillets and engaged through the compartment of the drive handle and engaged through the fitting for pivotally attaching the fitting to the drive handle.

The drive handle includes an aperture formed in the second fillet for engaging with the pivot shaft, and includes a screw hole formed in the first fillet for engaging with the pivot shaft and for solidly securing the pivot shaft to the drive handle.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a drive tool device in accordance with the present invention;

FIG. 2 is a perspective view of the drive tool device;

FIG. 3 is a side plan schematic view of the drive tool device;

FIG. 4 is a partial cross sectional view of the drive tool device, taken along lines 4-4 of FIG. 3; and

FIG. 5 is another partial cross sectional view illustrating the operation of the drive tool device.

### DETAILED DESCRIPTION OF THE PREFERRED EMBODIMENT

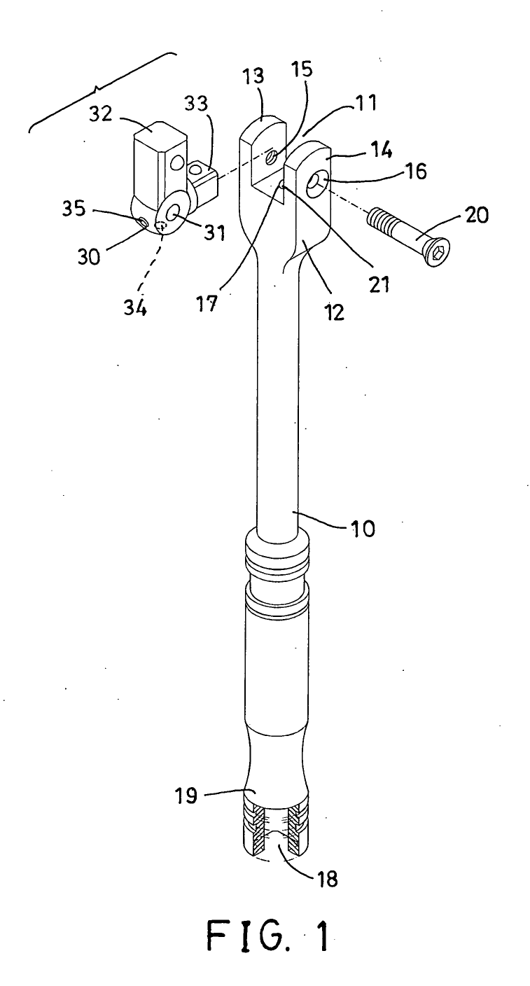

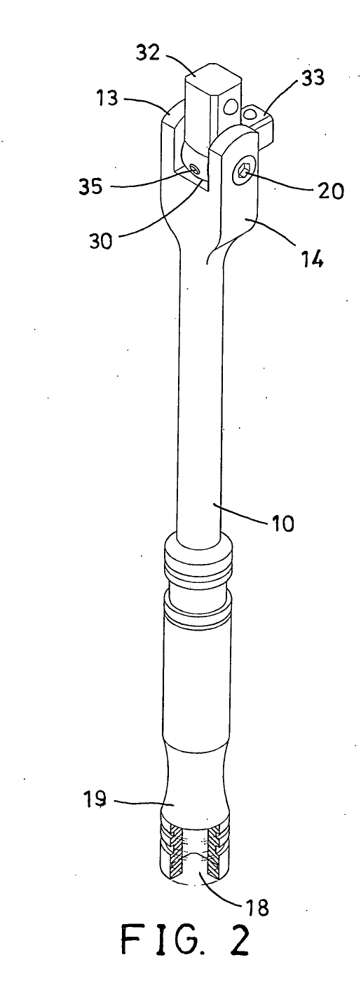

Referring to the drawings, and initially to FIGS. 1-4, a drive tool device in accordance with the present invention comprises an elongated shaft or drive handle 10 including a chamber or notch or space or compartment 11 formed in one end portion 12 thereof and formed or defined by or between two fillets 13, 14, and including a screw hole 15 formed in one of the fillets 13, and including an opening or aperture 16 formed in the other fillet 14 and aligned with the screw hole 15 that is formed in one of the fillets 13 and intersected or communicative with the compartment 11 of the drive handle 10.

A screw or bolt or fastener or pivot shaft 20 is engaged through the aperture 16 that is formed in the other fillet 14 of the drive handle 10, and extended or engaged through the compartment 11 of the drive handle 10, and threaded or engaged with the screw hole 15 that is formed in one of the fillets 13 of the drive handle 10 for solidly and stably attaching or mounting or securing to the drive handle 10, and it is preferable that the pivot shaft 20 is perpendicular to the fillets 13, 14, and also perpendicular to the longitudinal axis (L) of the drive handle 10 (FIG. 4) and straddled through the compartment 11 of the drive handle 10.

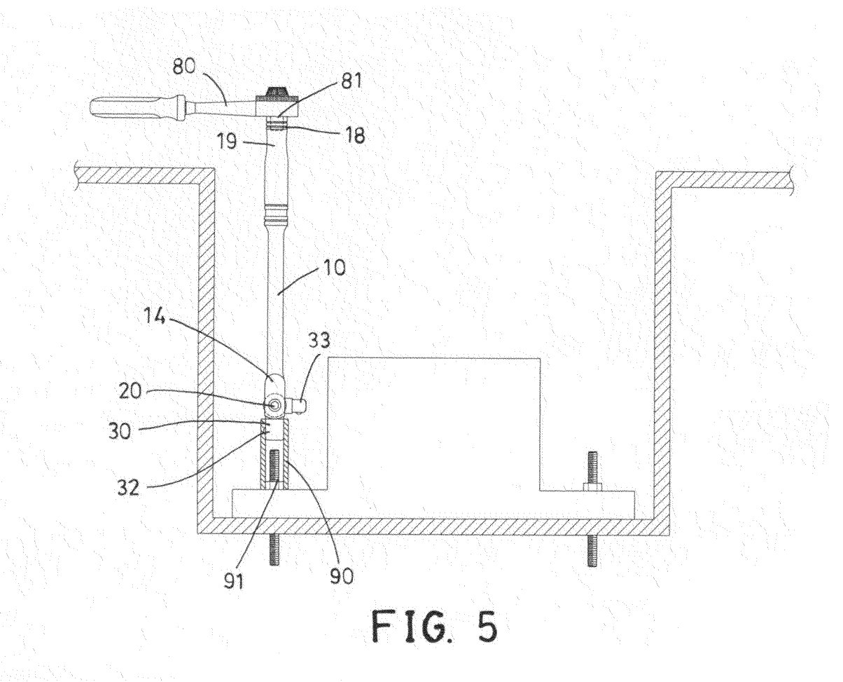

The drive handle 10 further includes a cavity 17 (FIG. 1) formed in the one end portion 12 thereof and communicative with the compartment 11 of the drive handle 10 for receiving or engaging with a spring-biased projection 21 which is partially extended into the compartment 11 of the drive handle 10, and further includes an engaging opening 18 formed in the other end portion 19 thereof for selectively receiving or engaging with a driving stud 81 of a driving tool 80 (FIG. 5) which may be used to selectively rotate or drive the drive handle 10.

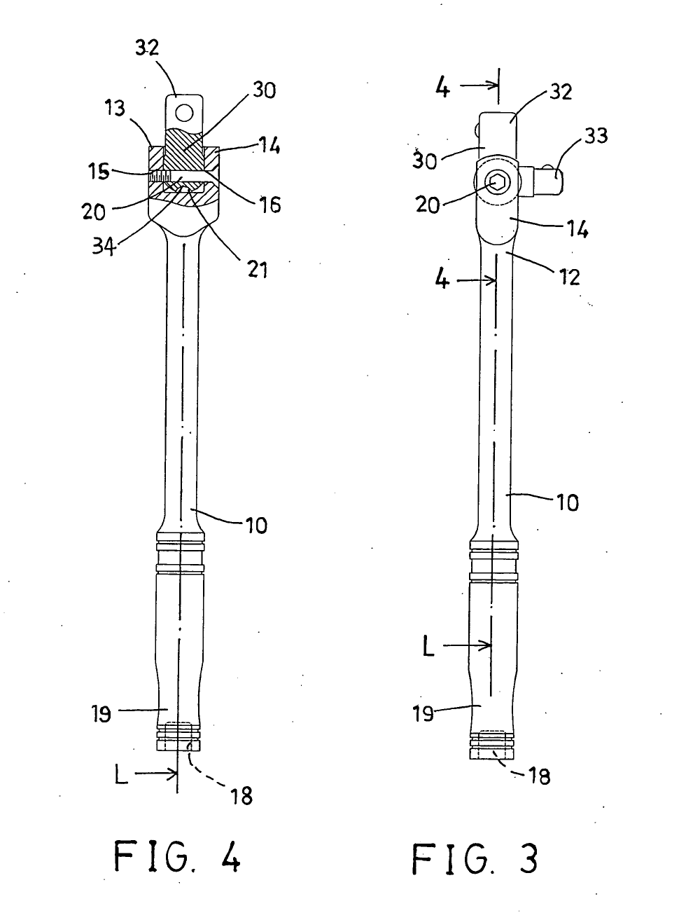

An adapter or fitting 30 includes an opening or orifice 31 formed therein for receiving or engaging with the pivot shaft 20 and for pivotally or rotatably attaching or mounting or securing or coupling the fitting 30 to the drive handle 10, and includes two or more shanks or stems or sockets or drives 32, 33 formed or provided thereon, and it is preferable, but not necessarily that the two drives 32, 33 are perpendicular to each other, for selectively or changeably aligning with the longitudinal axis (L) of the drive handle 10 (FIG. 3), and for allowing either of the two drives 32, 33 to be effectively rotated or driven by or with the drive handle 10 and/or the driving tool 80.

The fitting 30 further includes two or more recesses or depressions 34, 35 formed therein, and aligned with the drives 32, 33 respectively for selectively receiving or engaging with the spring-biased projection 21 (FIG. 3) which may be used to anchor or secure or retain or position the drives 32, 33 of the fitting 30 to the drive handle 10, and which may retain or position either of the two drives 32, 33 in line with the longitudinal axis (L) of the drive handle 10 (FIG. 3), and thus for allowing the drives 32, 33 of the fitting 30 to be effectively rotated or driven by or with the drive handle 10 and/or the driving tool 80.

It is to be noted that the drives 32, 33 may be selected from the drive shanks or the drive stems or the drive sockets or the drive studs, and may include identical or different sizes or dimensions or standards, such as ½″, ⅜″, or the like for selectively or changeably engaging with different tool elements or extensions or fasteners, such as the socket 90 as shown in FIG. 5, and thus for selectively or changeably actuating or driving or rotating the tool elements or extensions or fasteners 91 or the like.

In operation, as shown in FIG. 5, either of the drives 32, 33 may be selectively or changeably aligned with the longitudinal axis (L) of the drive handle 10 for allowing either of the two drives 32, 33 to be effectively and solidly and stably rotated or driven by or with the drive handle 10 and/or the driving tool 80, either of the drives 32, 33 may be easily and quickly engaged into the tiny space or working environment and may be easily and effectively and solidly and stably rotated or driven by or with the drive handle 10 and/or the driving tool 80.

Accordingly, the drive tool device in accordance with the present invention includes a fitting or adapter having two or more drives for selectively or changeably engaging with different tool elements or extensions or fasteners and for allowing the user to easily and quickly conduct various fastener actuating or driving operations.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A drive tool device comprising:
a drive handle including a first end portion and a second end portion, and including a longitudinal axis (L), and
a fitting pivotally attached to said first end portion of said drive handle with a pivot shaft for allowing said fitting to be pivoted and rotated relative to said drive handle,
wherein said fitting includes a first drive and a second drive for selectively and changeably aligning with the longitudinal axis (L) of said drive handle.

2. The drive tool device as claimed in claim 1, wherein said first drive and said second drive of said fitting are perpendicular to each other.

3. The drive tool device as claimed in claim 1, wherein said first drive and said second drive of said fitting include different dimensions.

4. The drive tool device as claimed in claim 1, wherein said drive handle includes a spring-biased projection for selectively engaging with said fitting and for retaining and positioning said fitting to said drive handle at selected positions.

5. The drive tool device as claimed in claim 4, wherein said fitting includes two depressions formed therein and aligned with said first and said second drives respectively for selectively engaging with said spring-biased projection and for selectively anchoring and positioning said first and said second drives of said fitting to said drive handle at selected positions.

6. The drive tool device as claimed in claim 1, wherein said drive handle includes a compartment formed in said first end portion thereof and defined between a first fillet and a second fillet for pivotally engaging with said fitting.

7. The drive tool device as claimed in claim 6, wherein said pivot shaft is engaged with said first and said second fillets and engaged through said compartment of said drive handle and engaged through said fitting for pivotally attaching said fitting to said drive handle.

8. The drive tool device as claimed in claim 7, wherein said drive handle includes an aperture formed in said second fillet for engaging with said pivot shaft, and includes a screw hole formed in said first fillet for engaging with said pivot shaft.

9. The drive tool device as claimed in claim 1, wherein said drive handle includes an engaging opening formed in said second end portion thereof.
